(19) United States
(12) Patent Application Publication
(10) Pub. No.: US 2013/0238354 A1
(43) Pub. Date: Sep. 12, 2013

(54) CONTEMPORANEOUS, MULTI-PHYSICIAN, ONLINE CONSULTATION SYSTEM

(71) Applicants: Michael J. Koren, Ponte Vedra Beach, FL (US); Donald E. Dawson, Jacksonville, FL (US)

(72) Inventors: Michael J. Koren, Ponte Vedra Beach, FL (US); Donald E. Dawson, Jacksonville, FL (US)

(73) Assignee: JAXRESEARCH SYSTEMS, LLC, Jacksonville, FL (US)

(21) Appl. No.: 13/863,120

(22) Filed: Apr. 15, 2013

Related U.S. Application Data
(63) Continuation-in-part of application No. 11/504,467, filed on Aug. 15, 2006, now Pat. No. 8,423,383.

(51) Int. Cl. G06F 19/00

(52) U.S. Cl. CPC G06F 19/3425
USPC 705/2

(57) ABSTRACT

The computer-implemented system of providing online medical consultation services in which professionals associated with the system formulate structured survey questions for medical professionals selected from a database, based upon information provided to the system by the user through an Internet capable communications device. The survey is provided to the medical professionals electronically and responses are provided to the system electronically. Responses may be quantitative and quantitative in nature and are compiled by the system, and a consensus is obtained and displayed in real time on the system website, to which the user has access through the Internet capable communications device. The system may be used to provide “nested” surveys in which the medical professionals have the option of responding to the initial survey by defining recipients for a further survey, which may be the same or different than the initial survey.

### CROSS-REFERENCE TO RELATED APPLICATIONS

This application is a continuation-in-part of U.S. patent application Ser. No. 11/504,467, filed Aug. 15, 2006, now U.S. Pat. No. 8,423,383, issued Apr. 16, 2013.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER

PROGRAM LISTING APPENDIX SUBMITTED ON COMPACT DISC

Not Applicable

### BACKGROUND OF THE INVENTION

1. Field of the Invention

The present invention relates to a medical consultation system and more particularly to a contemporaneous, multi-physician, online consultation system in which a user can obtain easily understandable medical opinions of many qualified, unbiased health care professionals and experts through the Internet. This system can provide information as to the sum of the opinions of medical professions for a variety of case scenarios and establish whether, and to what extent, a consensus of such opinions exists.

2. Description of Prior Art Including Information Disclosed Under 37 CFR 1.97 and 1.98

In the information age, effective decision making can be easily impaired by an overabundance of data. Internet access provides nearly limitless information on most subject matters. Ironically, these instantly available facts and opinions can paralyze rather than enhance decision making because capabilities to obtain information often overwhelm systems to meaningfully characterize and analyze the information received.

This dilemma is particularly true in health care fields where multiple sources of medical facts and opinions, often varying in strength and verifiability, inform medical decision making. This vast volume of medical data often presented in an unfamiliar format can lead to patient confusion. This confusion is further complicated by competing claims often arising from the dissemination of medical information by parties with proprietary interests in health care products or services.

The opinions of well intentioned qualified health care practitioners may also differ. Medical practitioners make recommendations based on their personal experiences and data known to them. Because of the vastness of medical information, health care practitioners may weigh medical information differently resulting in the rendering of patient medical opinions which may, in some cases, conflict with one another. If medical professionals can offer different medical advice for the same case scenario, it is not surprising that medically untrained patients can be easily confused and frustrated by the amount and variability of available medical information.

Ideally, patients should be able to review the best consensus opinions for all their health care concerns. Building a system to enable this consensus opinion generation would require access to qualified, unbiased, health care professionals who are familiar with and can apply their collective experience to an individual case. This system would also be able to rapidly evaluate data, be scaleable by numbers of health care providers or narrowness of expertise as cases require, and have an output that is produced contemporaneously, is easily understandable and reflects the weight of medical evidence when differences of opinion arise. In the perfect system, the health care providers would have adequate incentive to respond rapidly to patient scenarios once presented yet derive no personal gain that could bias recommendations when patients follow the opinions rendered.

Currently, efforts to create consensus opinions in medical fields occur through expert committees. These committees may be brought together by government entities or elements of organized medicine or medical industry. These committees are often charged with reviewing large bodies of medical information and crafting consensus statements when possible. Though the work of these groups is quite valuable, inevitably it is slow, often non-specific and cannot address the nuances of medical care relevant to individual patients.

Because of these limitations, an individual patient who seeks to obtain a consensus medical opinion on his or her specific health care circumstances can not be sure if this goal is met. At best, he or she could seek the advice of a physician and perhaps a second opinion or two and trust that this advice is in line with consensus. He or she may also do personal research using a vast variety of medical sources. Unfortunately, except for the exceptionally educated patient perhaps, finding a consensus of opinion would be more guesswork than science.

The present invention relates to a system that provides for contemporaneous multi-physician consultations and an output to allow patients to easily understand the strength of consensus medical views. It uses information technology systems integrated with human resources to produce an output that quickly enables case by case generation of consensus opinions for health care matters or establishes that no consensus exists. The system also compensates health care providers for their expertise without creating financial incentives that can bias decision making. Based on our review of the medical literature and prior art, no system for providing contemporaneous, simultaneous multiple physician consultations with a user friendly output exists.

The system of the present invention can employ a “nested” or “tiered” approach in which medical professionals selected to receive an initial survey have the option of defining a group of the recipients for a further survey, which further survey may be the same or may be different than the initial survey. This approach is particularly well suited for use in clinical trials, where it can assist in the design, the setting of criteria for and the recruitment of participants for the clinical trial, as well as in the analysis and disseminating of the results of the clinical trial. Other applications would include extracting information for medical education events or for market research purposes when the initial user needs the assistance of experts to identity and contact further groups who might best address the issue at hand.

The system of the present invention is also well suited for use with various types of mobile communications devices, such as smart phones and tablets, through which system users and the system can communicate. Such devices permit communications from any location where mobile communications service is available, at any time.

It is, therefore, a prime object of the present invention to provide a system providing contemporaneous, simultaneous multiple physician consultations with a user friendly output.

It is a further object of the present invention to provide a system for providing contemporaneous, simultaneous multiple physician consultations through the Internet.

It is a further object of the present invention to provide a system for providing contemporaneous, simultaneous multiple physician consultations wherein the individual opinions of the consulting physicians are reported to the user in real time.

It is a further object of the present invention to provide a system for providing contemporaneous, simultaneous multiple physician consultations wherein the sum of the opinions of the consulting physicians is reported to the user in real time.

It is a further object of the present invention to provide a system for providing contemporaneous, simultaneous multiple physician consultations wherein whether, and to what extent, a consensus of the opinions of the consulting physicians is present is reported to the user through a graphical representation.

It is a further object of the present invention to provide a system for providing contemporaneous, simultaneous multiple physician consultations in which medical professionals selected to respond to an initial survey can respond by defining a group of recipients to receive a further survey, which may be the same or different from the initial survey.

It is a further object of the present invention to provide a system for providing contemporaneous, simultaneous multiple physician consultations in which a “nested” or “tiered” approach is employed for purposes relating to clinical trials.

It is a further object of the present invention to provide a system for providing contemporaneous, simultaneous multiple physician consultations in which a “nested” or “tiered” approach is employed for purposes of structuring content or disseminating information for medical educational events.

It is a further object of the present invention to provide a system for providing contemporaneous, simultaneous multiple physician consultations in which a “nested” or “tiered” approach is employed for market research purposes.

It is a further object of the present invention to provide a system for providing contemporaneous, simultaneous multiple physician consultations wherein users of the system can communicate with the system through any type of Internet capable communications device, including mobile devices such as smart phones and tablets.

### BRIEF SUMMARY OF THE INVENTION

The above objects are achieved by the present invention which relates to a computer-implemented system of providing online medical consultation services by a team of medical professionals. The system is accessed by a user who connects to a website. The user selects the level of consultation services desired. The user is provided with a payment demand, based upon the level of services selected. The user submits the payment information on a form provided. The submitted payment information is verified.

A case submission form is then provided to the user requesting information relating to desired medical consultation. The user provides the requested information on case submission form.

The submitted information on the case submission form is reviewed by a medical professional. A determination is made if additional information is required to process a case. If so, the additional information is requested from the suitable source. It is determined if the case is ready for processing at that point.

When the case is ready for submission to a panel of medical professionals, members of the professional team are selected for consultation on the case. The system employs a software program to select appropriate medical professionals from a database. Selections from the database can be sorted by various characteristics of the medical professionals such as age, medical specialty, gender or geographical location. The selected professionals are forwarded the particulars of the submitted case via the Internet and e-mail. Structured questions are submitted with the particulars of each case. The selected medical professionals review the submitted case particulars and each member provides their medical opinion via Internet.

The submitted opinions are recorded and answers to structured questions are tallied. The opinions are also displayed in real time on the system website to which the user has access.

In addition, the submitted opinions are compiled to form a graphical representation of the compiled opinions. The graphical representation is displayed on the website to illustrate if, and to what extent, a consensus of opinion exists among the polled professionals.

The step of reviewing information on the provided case submission form includes parsing the information on the case submission form and comparing same to defined criteria using a software program. The user is notified if information is not acceptable. In that case, the user is permitted to revise the unacceptable information. The revised information is parsed and stored, if acceptable.

The system also includes a program that generates a message to the user via the Internet including instructions for logging into a website using a user name and password.

Further, assets consisting of text, graphics, animations, audio and video information relating to the case are stored. One or more of the stored assets are selected. The selected assets may be utilized to create the message to the user.

The step of verifying payment information includes notifying the user if the payment is not validated.

The system further allows a “view only” option that provides a user with access to cases stored in the website displaying the medical opinions. A user can find various types of cases previously reviewed by medical professionals using a system specific search engine, if the “view only” option is selected.

The level of services selected by user determines the extent the user can access the website with displayed opinions. It also determines the complexity of the case that a user may submit for consultation.

The system also includes computer-implemented software to select and register medical professions for participation. That is done by inviting potential medical professionals to participate and providing each potential medical professional that agrees to participate with website login information. When the professional successfully logs into the website, a welcome message is sent. The professional is provided with a contract for signature, which is signed and returned. The information on the signed contract is validated. Personal and/or professional information is solicited from each medical professional with a validated contract. The information provided by the medical professional is further validated and stored. Approval of the medical professional as a member of team is then confirmed.

The system includes software that periodically checks the website for new case submissions. The step of determining if additional information is required to process the case and, if so, requesting same, includes forwarding information to a health care provider who reviews each new case submitted. If the selected level of the submitted case requires user interaction, the user is contacted. The case is reviewed with contacted user and additional information is obtained from contacted user, if necessary.

The system further allows for one or more structured questions to be generated relating to a submitted case. The system also compiles one or more answers to the questions and stores the questions and answers.

The step of selecting members of the team for consultation on the case includes sending a survey to each selected member of the team; reviewing the survey results; and posting the survey results in real time.

The step of selecting members of the team for consultation on the case also includes reviewing previously stored information about members of the team; and selecting members for consultation on the submitted case based upon the reviewed information.

The step of selecting members of the team for consultation includes retrieving a list of approved medical professionals; selecting a medical professional from the list; reviewing previously stored information about the medical professional selected from the list and comparing same with defined criteria.

The step of advising selected team members of the particulars of the case via the Internet includes contacting a selected team member to notify him or her that there is a case for consultation; providing the contacted member with a link to the website; displaying the case particulars on the website; and providing a survey to the member for recording his or her opinion.

The system also determines if the survey was already answered by the contacted member and determines if the survey quota has already been met.

The system also allows a selected health care professional to opt out of participation in the consultation and makes note of this decision.

The step of displaying the case particulars includes displaying detailed information about the case on the website. It also includes displaying images relating to the case on the website.

The system also includes a provision for the user to log onto a website, select a case, view the details of case, view case questions, view the displayed opinions from team members and view displayed case comments from the team members.

The step of having the selected health care professionals review the case and submit an opinion includes providing the team member with a survey to report his or her opinion regarding submitted case and displaying the survey results on a website. The survey results are displayed on the website in real time.

The step of generating a graphical representation of the survey results includes displaying same on the website in real time.

Another aspect of the present invention relates to a method of providing medical survey results utilizing a computer-implemented system connected to the Internet. The method includes the steps of:

(a) creating a database of potential recipients of an initial survey, along with information about each such potential recipient;

(b) user seeking medical survey results accesses system and submits information to system regarding the medical issue for which the user desires survey results;

(c) group of recipients of an initial survey qualified with regard to the medical issue for which the user desires survey results are selected by the system based upon information in the database;

(d) professionals affiliated with system formulate initial survey including information regarding medical issue for which user desires survey results and one or more structured questions, and forward initial survey to group of recipients selected to respond to the initial survey;

(e) selected group of recipients of the initial survey review initial survey and formulate responses which are forwarded to system, at least one such response to the initial survey including a definition of a group of recipients for a further survey;

(f) selecting a group of recipients for the further survey in accordance with the definition of a group of recipients for a further survey included in the at least one response of the group of recipients of the initial survey;

(g) formulating the further survey and forwarding the further survey to the group of recipients selected for the further survey;

(h) recipients of the further survey review further survey and provide responses to system;

(i) system uses responses to formulate medical survey results sought by user, and

(j) system displays results on website accessible to the user.

The step of selecting a group of recipients for a further survey includes the steps of: recipient of initial survey supplies system with information relating to the group of recipients for a further survey defined by such recipient of initial survey and system selects group of recipients for further survey based upon such supplied information.

The method further includes the step of either providing or denying access by group of recipients of the further survey to the responses to initial survey depending on statistical and blinding considerations.

The step of formulating the further survey includes the step of having at least one professional affiliated with the system review the responses to initial survey and prepare or edit the further survey including one or more structured questions, based upon responses to initial survey.

The step of formulating the further survey includes having the recipient of the initial survey that provided the at least one response defining a group of recipients for the further survey prepare the further survey including one or more structured questions.

The recipients of the initial survey may include medical professionals and the recipients of the further survey may include the patients of the medical professionals or colleagues or other experts.

When the medical survey results provided by the system relate to clinical trials, the recipients of the initial survey include medical professionals and the recipients of the further survey may include the patients of the medical professionals that are possible participants in such clinical trials or colleagues who may refer patients.

The system may use the responses to the initial survey to formulate the medical survey results sought by user.

The recipients of the initial survey may use the responses to the further survey to formulate their responses to initial survey and the system can use such responses to the initial survey to formulate the medical survey results sought by user.

The system may use the responses to the further survey to formulate medical survey results sought by user.

The group of recipients of the further survey may be directed to a website to obtain additional information about the medical issue for which user seeks medical survey results.

Another aspect of the present invention relates to a system for providing medical survey results utilizing a computer-implemented system connected to the Internet. The system includes a database of potential recipients of an initial survey, along with information about each such potential recipient. Means are provided for a user seeking medical survey results to access system and submit information to system regarding the medical issue for which the user desires survey results. Means are provided for selecting a group of recipients of an initial survey qualified with regard to the medical issue for which the user desires survey results based upon information in the database. Means are provided for formulating an initial survey including information regarding medical issue for which user desires survey results and one or more structured questions, and for forwarding the initial survey to group of recipients selected to respond to the initial survey. Means are provided for the selected group of recipients of the initial survey to review the initial survey and to respond to system. At least one such response to the initial survey includes a definition of a group of recipients for a further survey. Means are provided for selecting a group of recipients for a further survey in accordance with the definition of a group of recipients for a further survey included in the at least one response to the initial survey. Means are provided for formulating the further survey and for forwarding same to group of recipients selected for the further survey. Means are provided for the recipients of the further survey to review the further survey and to provide responses to system. Means are provided for using the responses to formulate medical survey results sought by user. Means are also provided for displaying the results on a website accessible to the user.

The means for selecting a group of recipients for a further survey includes means for the recipient of the initial survey to supply the system with information relating to the group of recipients for a further survey defined by such recipient of initial survey and means for the system to select the group of recipients for the further survey based upon such supplied information.

The system further includes means for providing access by the group of recipients of the further survey to the responses to the initial survey if appropriate.

The means for formulating the further survey includes means for at least one professional affiliated with the system to review the responses to initial survey and to prepare the further survey including one or more structured questions, based upon the responses to the initial survey.

The means for formulating the further survey includes means for the recipient of the initial survey providing the response defining the group of recipients for the further survey to prepare the further survey including one or more structured questions.

The medical survey results provided by the system may relate to clinical trials. In that case, the recipients of the initial survey may include medical professionals and the recipients of the further survey may include the patients of the medical professionals that are possible participants of such clinical trials or colleagues who may refer patients.

The medical survey results provided by the system may relate to medical educational events. In that case, the recipients of the initial survey may include medical professionals and the recipients of the further survey may include the patients of the medical professionals or colleagues depending on the nature of the medical education.

The medical survey results provided by the system may relate to market research. In that case, the recipients of the initial survey may include medical professionals and the recipients of the further survey may include the patients of the medical professionals or colleagues depending on the nature of the market research.

The means for using responses to formulate the medical survey results sought by user may include means for using the responses to the initial survey to formulate the medical survey results sought by user.

The means for using responses to formulate medical survey results sought by user may include means for the recipients of the initial survey to use the responses to the further survey to formulate the responses to initial survey and means for using such responses to the initial survey to formulate the medical survey results sought by user.

The means for using responses to formulate medical survey results sought by user may include means for using the responses to the further survey to formulate the medical survey results sought by user.

The system also includes means for directing the group of recipients of the further survey to a website to obtain additional information about the medical issue for which the user seeks medical survey results.

Another aspect of the present invention relates to a system for providing online medical consultation services including quantitative and qualitative responses to surveys related to medical issues. The system includes means for creating a database of potential participating medical professionals, along with information about each the potential participating medical professionals, including the qualifications of the potential participating medical professionals. Internet capable communication means are provided for a user seeking medical consultation services to access the system. Internet capable communication means are provided for the user to submit information to the system regarding the desired medical consultation services. Means are provided for selecting a panel of medical professionals qualified to provide the desired medical consultation services based upon information in the database. Means are provided for electronically providing question(s) based on the user submitted information, and the user submitted information, to the medical professionals in the selected panel such that the medical professionals in the selected panel can formulate response(s) to provided question(s) and comments regarding user submitted information. Means are provided for electronically forwarding the responses and comments from the medical professionals in the selected panel to the system. Means are provided for calculating the degree of consensus of forwarded responses to questions. Means are provided for displaying the calculated consensus on a system website accessible to user. Means are also provided for displaying the comments forwarded from the medical professionals on a system website accessible to the user by Internet capable communication means.

The Internet capable communications means may include any mobile Internet capable communication means, such as a smart phone.

Another aspect of the present invention relates to a computer-implemented system for providing medical consultation services connected to the Internet, to form a consensus of opinions by a panel of medical professionals selected by the system. The system includes means for creating a database of potential participating medical professionals, along with information about each the potential participating medical professionals, including the qualifications of the potential participating medical professionals. Internet capable communication means are provided for the user seeking medical consultation services to accesses the system. Internet capable communications means are provided for the user to submit information to the system regarding the desired medical consultation services such that at least one professional affiliated with the system can review the information submitted by the user and structure one or more questions, based upon the user submitted information, for consideration by a panel of selected medical professionals. Means are provided for selecting a panel of medical professionals qualified to provide response(s) to the structured question(s) based upon information in the database. Means are provided for providing the structured question(s) to the medical professionals in the selected panel such that medical professionals in the selected panel can review the structured question(s) and create responses thereto. Means are provided for electronically forwarding the responses from the medical professionals in the selected panel to the system. Means are provided for compiling the responses forwarded to the system by the medical professionals in the selected panel. Means are provided for calculating the degree of consensus of the responses. Means are also provided for displaying the calculated consensus on a system website accessible to the user by Internet capable communication means.

The Internet capable communications means may include any mobile Internet capable communication means such as a smart phone.

Another aspect of the present invention relates to a computer-implemented system for providing medical consultation services connected to the Internet, integrated with human resources provided by professionals affiliated with the system, to form a consensus of opinions by a panel of medical professionals selected by the system. The system includes means for creating a database of potential participating medical professionals, along with information about each the potential participating medical professionals, including the qualifications of the potential participating medical professionals. Internet capable communications means are provided for the user seeking medical consultation services to accesses the system. Internet capable communications means are provided for the user to submit information to the system regarding the desired medical consultation services such that at least one professional affiliated with the system can review the information submitted by the user and structure one or more questions, based upon the user submitted information, for consideration by a panel of selected medical professionals. Means are provided for selecting a panel of medical professionals qualified to provide response(s) to the structured question(s) based upon information in said database. Means are provided for providing the structured question(s) to the medical professionals in the selected panel such that medical professionals in the selected panel can review the structured question(s) and create responses thereto. Means are provided for electronically forwarding the responses from the medical professionals in the selected panel to the system. Means are provided for compiling the responses forwarded to the system by the medical professionals in the selected panel. Means are provided for calculating the degree of consensus of the responses. Means are also provided for displaying the calculated consensus on a system website accessible to the user through Internet capable communications means.

The Internet capable communications means may include mobile Internet capable communication means, such as a smart phone.

Another aspect of the present invention relates to a method of providing online medical consultation services utilizing a computer-implemented system connected to the Internet to obtain quantitative and qualitative medical opinions from a panel of selected medical professionals. The method includes the steps of:

(a) creating a database of potential participating medical professionals, along with information about each potential participating medical professional, including the qualifications of the potential participating medical professional;

(b) user seeking a medical consultation accesses the system through Internet capable communications device;

(c) user submits information regarding the desired medical consultation through Internet capable communications device;

(d) system selects a panel of medical professionals qualified to provide desired medical consultation based upon information in the database;

(e) question(s) based on user submitted information and user submitted information are provided to the medical professionals in the selected panel;

(f) medical professionals in the selected panel formulate response(s) to provided question(s) and comments regarding user submitted information;

(g) responses and comments from the medical professionals in the selected panel are forwarded to the system; and

(h) system calculates the degree of consensus of responses to questions, and displays same, along comments from the medical professionals, on a system website accessible to the user through Internet capable communications device.

The Internet capable communications means may include any mobile Internet capable communication means, such as a smart phone.

Another aspect of the present invention relates to a system for providing online medical consultation services including quantitative and qualitative medical opinions from a panel of selected medical professionals. The system includes means for creating a database of potential participating medical professionals, along with information about each the potential participating medical professionals, including the qualifications of the potential participating medical professionals. Internet capable communications means are provided for a user seeking medical consultation services to access the system. Internet capable communications means are provided for user to submit information to the system regarding the desired medical consultation services. Means are provided for selecting a panel of medical professionals qualified to provide the desired medical consultation services based upon information in said database. Means are provided for electronically providing question(s) based on the user submitted information, and the user submitted information, to the medical professionals in the selected panel such that the medical professionals in the selected panel formulate response(s) to provided question(s) and comments regarding user submitted information. Means are provided for electronically forwarding the responses and comments from the medical professionals in the selected panel to the system. Means are provided for calculating the degree of consensus of forwarded responses to questions. Means are provided for displaying the calculated consensus on a system website accessible to user. Means are also provided for displaying the comments forwarded from the medical professionals on a system website accessible to the user through Internet capable communications means.

The Internet capable communications means may include any mobile Internet capable communication means, such as a smart phone.

### BRIEF DESCRIPTION OF THE SEVERAL VIEWS OF DRAWINGS

To these and to such other objects that may hereinafter appears, the present invention relates to a contemporaneous, multi-physician, online consultation system as described in detail in the following specification and recited in the annexed claims, taken together with the accompanying drawings, in which:

FIG. 1 is a system flowchart overview and describes the components and functionality of the consumer access/case submission system;

FIG. 1A describes the components and functionality of the Dynamically Generated Email system;

FIG. 2 is a detailed flowchart and shows the steps from when the consumer connects to the website until they are presented with the appropriate data and access;

FIG. 3 is a detailed flowchart and shows what the doctors/medical professionals see (on any Web accessible device) as they go through the Signup process;

FIG. 4 is a detailed flowchart and shows what the Case Approval process is after the consumers have submitted a case;

FIG. 5 is a detailed flowchart and shows what the Doctor/Medial professional approval process is after doctors/medical professionals have completed the Signup process;

FIG. 6 is a detailed flowchart and shows the process in which a doctor/medical professional sees (on any Internet accessible communications device) and goes through to submit answers to the surveys emailed to them;

FIG. 7 is a detailed flowchart and is a continuation of the login process from FIG. 2; and

FIG. 8 is a detailed flow chart of a continuation of the survey process depicted on FIG. 6 illustrating an application of the system which employs a “nested” or “tiered” approach wherein medical professionals selected to respond to an initial survey and have the option of responding by defining a group of recipients to receive a further survey.

### DETAILED DESCRIPTION OF THE INVENTION

The different figures presented illustrate the steps involved in implementing the system of the present invention. However, it should be understood that the figures show preferred embodiments of the invention for purposes of illustration and that numerous modifications could be made thereto without deviating from the general concept of the present invention.

The system of the present invention can be utilized by the vast number of Internet capable communications devices including smartphones, tablets and similar devices currently in the market which could be used for communications between a system user and the system. For example, a system user could access the system and provide information to the system regarding the subject matter of the user's inquiry. Moreover, users could obtain the results of the consultation by accessing a system website using such Internet capable communications devices.

If configured for use with Internet capable communications devices, the system would detect if a smartphone or other smart device is being used and will format the case data, photos, surveys, comments and results for viewing and/or answering using such devices. The system can also utilize the hardware capabilities of the smartphones/smart devices, such as the camera feature for submitting photos for a submission of a new case or the GPS feature for locating possible survey recipients in a particular geographic area.

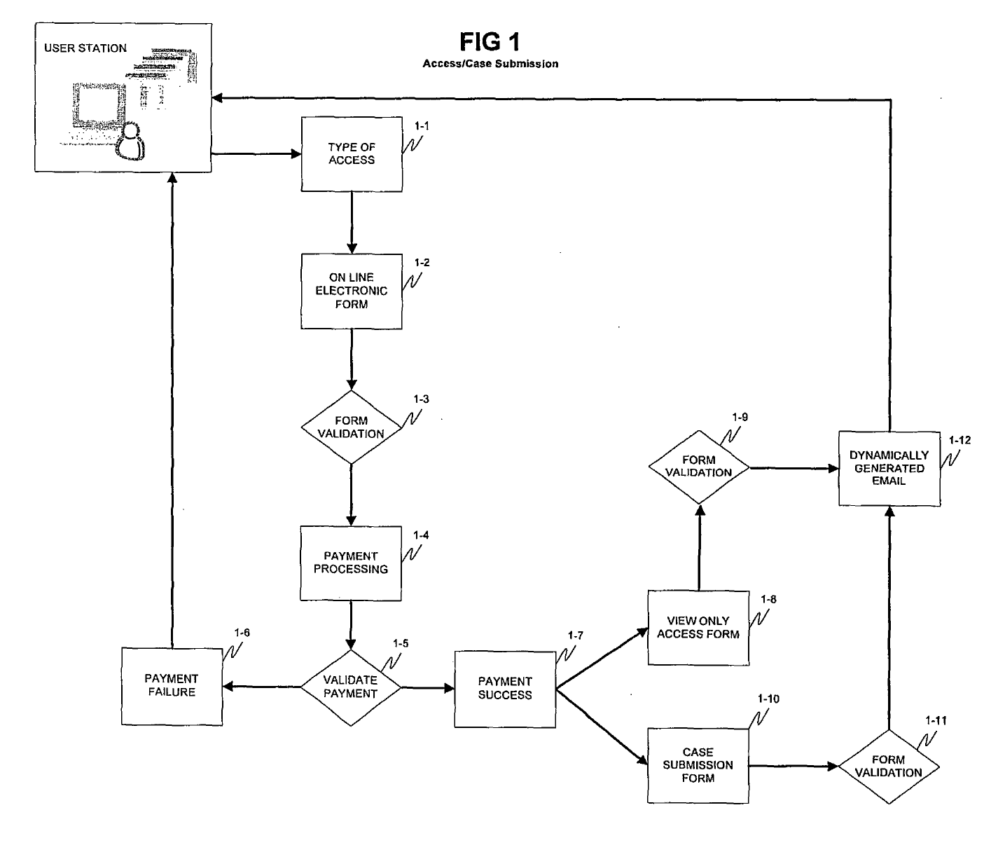

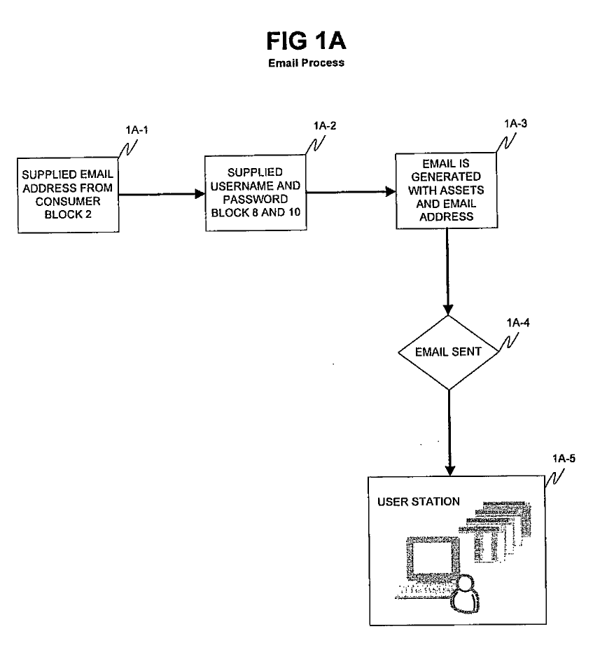

FIG. 1 is a system flowchart overview and describes the components and functionality of the consumer access/case submission system. The block numbers in FIG. 1 match the Block numbers below.

Block 1-1—Type of Access. The user of the system indicates which type of access and/or medical case to submit. The different types of access/submissions include, for example, a temporary pass which can be defined in hours, days, etc, a full pass which allows access for set period of time (ie. a number of months or years), and submission of a medical case at different levels of complexity. The selected type of access will determine what type of form and amount of payment is required and sent to the display screen of the computer of the user. Once the type of access is selected, the user is sent to the Online Electronic Form.

Block 1-2—OnLine Electronic Form. The user fills out the online form from a User Station (which could include any Internet capable communications device, whether mobile, such as a smartphone or tablet, or non-mobile, such as a: PC or WebTV. This form will gather input from the user that will be validated at submission.

Once the form is completed, the user submits the form electronically to the systems server by clicking on a submit button that is on the display screen of the user. Transmission can be done through either wire or wireless communications.

Block 1-3—Form Validation. The submitted form data are then parsed through via software code against defined criteria. The form data must meet minimum defined criteria to be accepted for processing. If a section of the form data is not acceptable, the user is notified with a screen on their display. The user is allowed to correct the unacceptable data. Once corrected, or if all data are considered acceptable, the form data are submitted for data processing.

Block 1-4—Payment Processing. The form data that were submitted are added to a database. A list of payment options, such as PayPal, Visa, Mastercard, etc (any type of payment whether electronic or mailed in) will be sent to the user display. Once the user has selected the type of payment, and submits the required amount of payment, the user is redirected to a results display that validates the payment.

Block 1-5—Validate Payment. If payment was unsuccessful for any reason, the user is directed to a failure of confirmation page which is sent to their display.

Block 1-6—Payment Failure. If the processing of payment was rejected, declined or unsuccessful for any reason in Block 1-5, the user is displayed with a payment failed screen and, if available, the reason of the failure will be displayed. The user may resubmit for processing by starting at Block 1-1.

Block 1-7—Payment Success. Upon successful payment, the user will be redirected to an electronic form which will request certain information depending on which type of access/case the user has selected. The types of forms are explained in Block 1-8 and Block 1-10 below.

Block 1-8—View Only Access Form. This is an electronic form that allows the consumer to create a Username and Password that they will use to access the Secure Login Area.

Block 1-9—Form Validation. The submitted form data are parsed through via software code against defined criteria. The form data must meet minimum defined criteria to be accepted for processing. If a section of the form data is not acceptable, the user is notified with a screen on their display and allowed to correct the unacceptable data. Once corrected, or if all data are considered acceptable, the form data are submitted for data processing.

Block 1-10—Case Submission Form. This form is used to gather input from the user that will be validated at submission. This will also allow the user to upload/copy a file up to the system server. The form also allows the user to create a Username and Password that they will use to access the Secure Login Area.

Block 1-11—Form Validation. The submitted form data are then parsed through via software code against defined criteria. The form data must meet minimum defined criteria to be accepted for processing. If a section of the form data is not acceptable, the user is notified with a screen on their display and allowed to correct the unacceptable data. Once corrected, or if all data are considered acceptable, the form data are submitted for data processing.

Block 1-12—Dynamically Generated Email. The submitted form data from Block 1-9 and Block 1-11 are then added to the database. From the data gathered in the database, an email is dynamically generated and delivered in real-time by electronic means to the user's supplied email address through wire or wireless communications. The email contains a welcome message, instructions for logging into the system along with the Username and Password that the user created in Block 1-8 and Block 1-10.

All of the assets of the dynamically generated emails are stored on the secured server (computer where the website exists) that are used in the system described in FIG. 1A. These assets can consist of text, graphics, animations, audio and video information. These dynamically generated emails can comprise some combination of these assets. All assets used for the dynamically generated emails can be changed based upon submitted user data, as well as company needs. There is no limit to the number and type of dynamically generated emails that can be created and delivered.

FIG. 1A illustrates the components and functionality of the Dynamically Generated Email system.

Block 1A-1. Email addresses that were gathered and stored in the database from FIG. 1 Block 1-2 are retrieved.

Block 1A-2. Username and Passwords that were gathered and stored in the database from FIG. 1 Blocks 1-8 and 1-10 are retrieved.

Block 1A-3. All information from Blocks 1-1 and 1-2 are assembled into an email message to be sent to the consumer.

Block 1A-4. The dynamically generated email is emailed to the consumer's email address. Information in the message may include but is not limited to: a welcome message, login information, privacy information, combination of assets, etc.

Block 1A-5. The user receives the email.

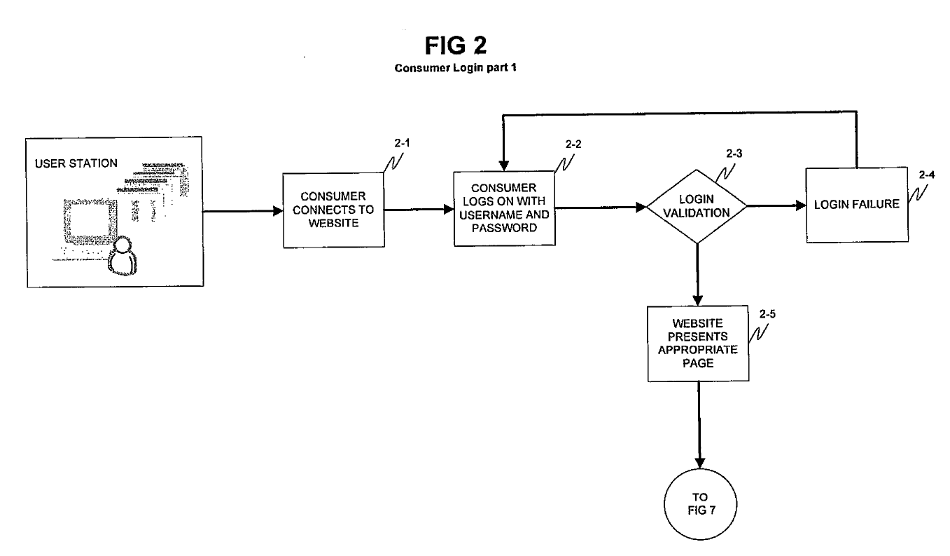

FIG. 2 is a detailed flowchart and shows the steps from when the user connects to the website until they are presented with the appropriate data and access.

Block 2-1. User connects to the website from a web accessible device and navigates to the page that allows the user to enter in their username and password.

Block 2-2. User utilizes the username and password that they created when they filled out the electronic form from FIG. 1 Block 1-2 and was emailed to the consumer.

Block 2-3. The provided username and password is then used to search the database of existing data to verify that the username and password presented is correct. If there is no match in the database to the username and password provided then the user is redirected to a Login Failure page, Block 2-4, or if a successful match was found, the user is redirected to a page that is dynamically generated based on level of access, Block 2-5.

Block 2-4. If the user provided username and password is incorrect, they will be redirected to this failure page informing them that either the username or password was incorrect. It also allows them to click on a link/button that redirects them back to the logon page, Block 2-2, so that they can repeat the login process.

Block 2-5. If the user provided username and password is correct, they will be redirected to a web page that is dynamically generated showing or hiding sections of the website based on the level of access the user chose during the access/case submission process, FIG. 1 Block 1-1

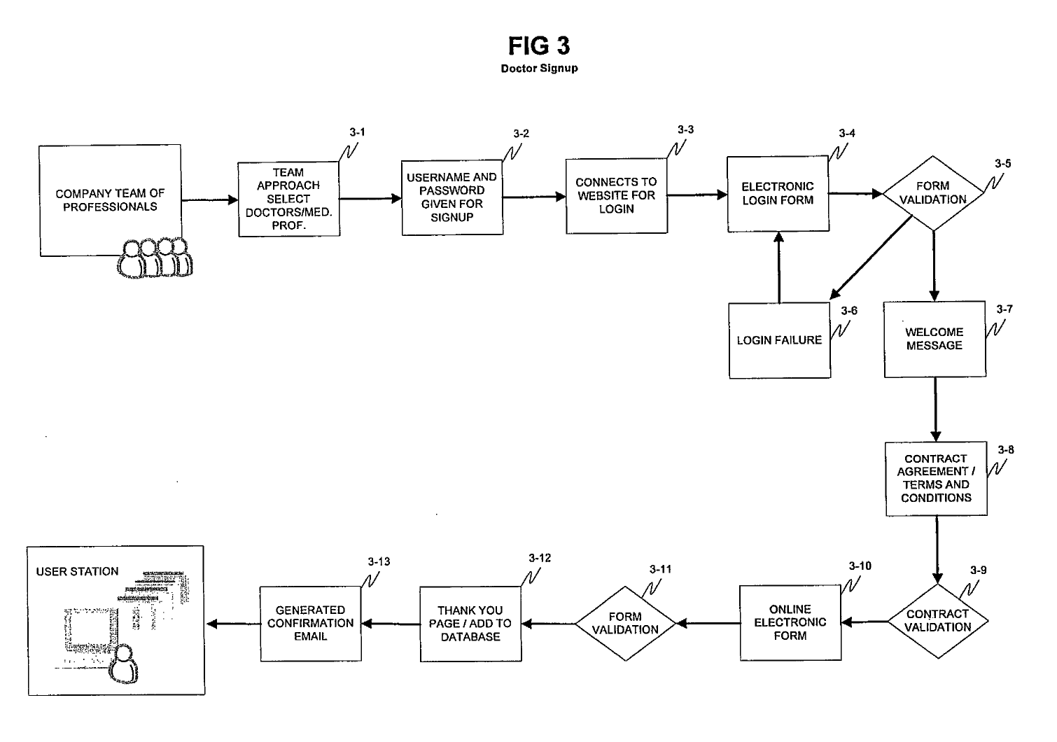

FIG. 3 is a detailed flowchart and shows what the doctors/medical professionals see (on their mobile or non-mobile Internet capable communications device) as they go through the Signup process. It is important to note that this is not the only method for signing up doctors/medical professionals and adding them to our database for future use and processing. They can be signed up and added by phone, email, fax or any other means of communication or added to the database via webpage, programming code, or other means of database communications.

Block 3-1. The team of professionals approaches doctors/medical professionals inviting them to participate in part of our system of answering surveys.

Block 3-2. If the doctors/medical professionals from Block 3-1 agreed to participate, they receive a username and password along with a website address for the signup process to continue. The username, password, and website address can be given over the phone, email, pager or any other means of communications.

Block 3-3. Once the doctors/medical professionals obtain the username and password, they connect via any web capable device connecting to the provided web site address.

Block 3-4. The doctors/medical professionals input the username and password and click a submit button on an electronic form.

Block 3-5. The submitted username and password is then used to search the database of existing data to verify that the username and password presented is correct. If there is no match in the database to the username and password submitted, the doctor/medical professional is redirected to a Login Failure page, Block 3-6, or if a successful match was found, the doctor/medical professional is redirected to a welcome page, Block 3-7.

Block 3-6. If the submitted username and password was incorrect, a Login Failure page will be displayed notifying them that the username and password was incorrect. They will also be presented with a link back to the electronic login page, Block 3-4.

Block 3-7. If the submitted username and password was correct, a Welcome page will be displayed notifying them the login was successful. This may contain assets including but not limited to text, animations, audio, video, etc. Once the doctors/medical professionals have finished with the welcome page they will have a link allowing them to continue with the signup process taking them to the Contract Agreement/Terms and Conditions page, Block 3-8.

Block 3-8. In order for each doctor or medical professional to participate in the survey system they must have read and signed a contract agreement agreeing to the terms and conditions of the system. This can be accepted in either paper or electronic form. In order to continue, they must select the electronic form that they have read and agree to the contract. The provided link will allow them to submit the agreement for validation.

Block 3-9. The submitted form data are then parsed through via software code against defined criteria. The form data must meet minimum defined criteria to be accepted for processing. If a section of the form data is not acceptable, the doctor/medical professional is notified with a screen on their display and allowed to correct the unacceptable data. Once corrected, or if all data are considered acceptable, the form data are submitted for data processing.

Block 3-10. This form will gather input from the doctors/medical professionals that will be validated at submission. The information gathered may include but not limited to personal, geographical and professional information.

Block 3-11. The submitted form data are then parsed through via software code against defined criteria. The form data must meet minimum defined criteria to be accepted for processing. If a section of the form data is not acceptable, the doctor/medical professional is notified with a screen on their display and allowed to correct the unacceptable data. Once corrected, or if all data are considered acceptable, the form data are submitted for data processing.

Block 3-12. After successful submission of form data the doctors/medical professionals are then redirected to a successful page. The data submitted are also added to the database.

Block 3-13. Once the data have been added to the database, an email is generated and sent to doctor/medical professional with confirmation completing the signup process.

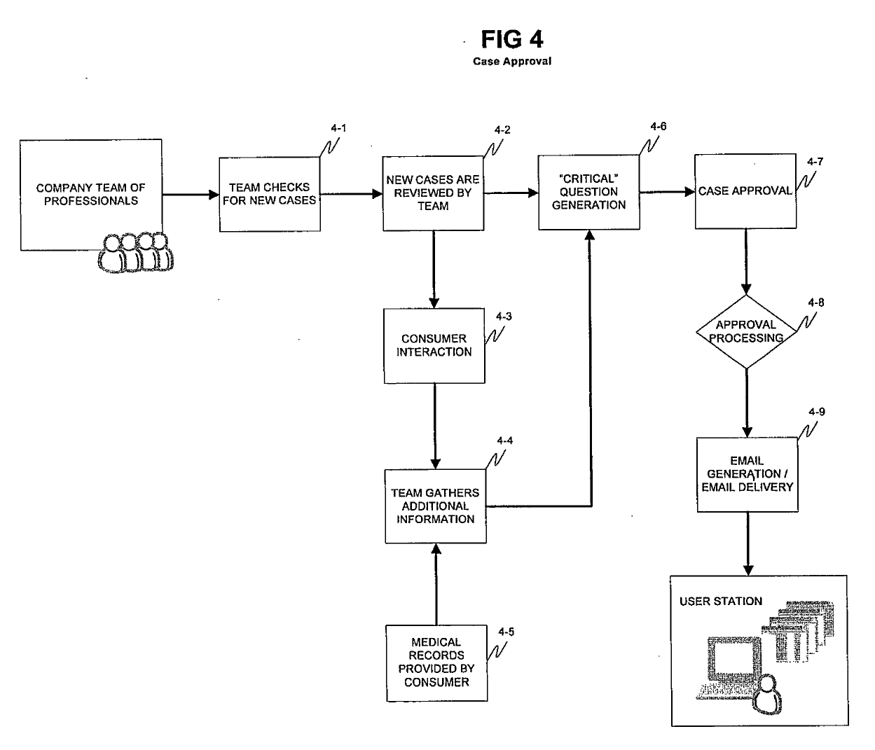

FIG. 4 is a detailed flowchart and shows what the Case Approval process is after the users have submitted a case.

Block 4-1. A team of company professionals connect to the website and check for newly submitted case.

Block 4-2. The team then reviews all newly submitted cases. They take each case and make sure that it is properly formatted; text and submitted photos are cleaned for public viewing, etc. Depending on the level of case submitted, it may require interaction with the consumer who submitted the case, Block 4-3, or the case may be reviewed and sent on to the next step without consumer interaction, Block 4-6.

Block 4-3. If the level of submitted case requires consumer interaction, someone from the team will contact the user via email, phone, cell, or any other means of communication.

Block 4-4. The team member will review the submitted case with user and gather additional information about the submitted case to better construct a presentable case.

Block 4-5. If necessary, the team will request medical records that will assist them in creating the survey questions. These records can be transmitted by fax, mail, electronic or any other means of transmission.

Block 4-6. Once the cases have been reviewed and all necessary information and documents have been gathered, the team will then begin the “Critical” Question Generation process. During this process, the team will generate a survey question or multiple survey questions. The number of questions will vary from case to case. Along with each question, the team will generate answers and the number of answers will vary question to question. All questions and answers are added to the database.

Block 4-7. When all the questions and answers have been generated, the case details have been reviewed and the photos have been reviewed, the case has one final review and then is ready for the selection process.

Part of the approval process is the selection of doctors/medical professionals to receive the case. The selection of doctors/medical professionals and selection criteria may vary from case to case. The approval selection can send the survey to all doctors/medical professionals or to a selected list based on criteria such as but no limited to geographical location, profession specialties, age, gender, and various other collected information that is stored in the database. After the selection process the case is approved.

Block 4-8. The selection of criteria is processed and added to the database and prepares the data from the approval page and retrieved database data for email processing.

Block 4-9. An email is generated for each of the selected doctors/medical professionals and delivered by email. The email contains information identifying the email with the survey system, a website link back to the actual survey, policy information, and other asset related material such as, but not limited to text, images, animations, audio and video.

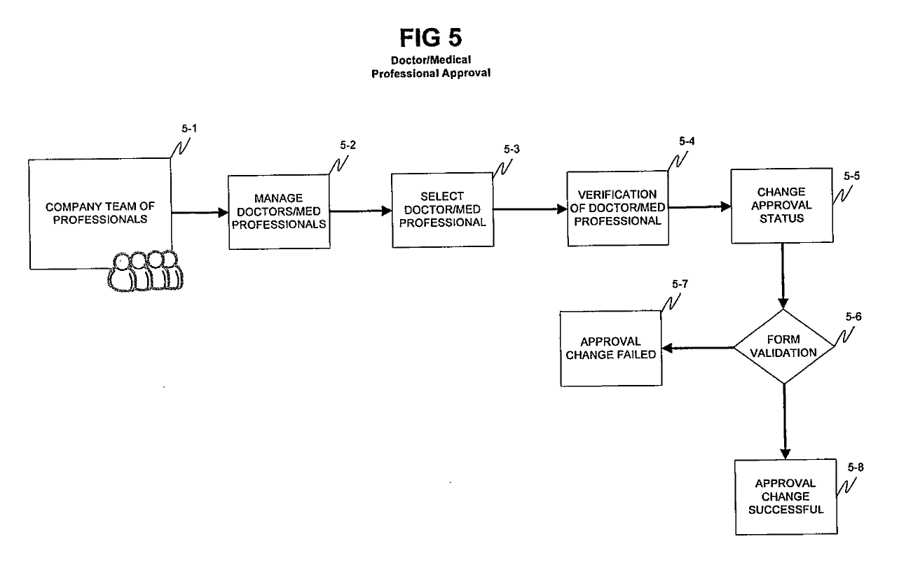

FIG. 5 is a detailed flowchart and shows what the Doctor/Medial professional approval process is after doctors/medical professionals have completed the Signup process.

Block 5-1. The team members connect to a website that manages the data in the database. The data in the database can also be managed using other methods that can connect to and make changes to the database.

Block 5-2. The team members then click on Manage Doctors/Medical Professionals.

Block 5-3. This will retrieve and display a list of doctors/medical professional from the database. The team members locate and select the doctor/medical professional in question.

Block 5-4. The doctor/medical professional data are displayed and can include but are not limited to personal data, professional data, approval status, etc. In order for our select panel of doctors/medical professionals to receive the emails that allow them access to the cases/surveys they have to have an approval status.

Block 5-5. The team members then review and cross-check information about the doctor/medical professional to verify credentials. Once the verification is complete, the status of the doctors/medical professionals is changed to Approved. After the status or any other changes have been made, the team member submits the data for validation.

Block 5-6. The data in the submitted form are parsed through via software code against defined criteria. The form data must meet minimum defined criteria to be accepted for processing. If a section of the form data is not acceptable, the team member is notified with a screen on their display and allowed to correct the unacceptable data. Once corrected or if all data are considered acceptable, the form data are submitted for data processing.

Block 5-7. If the submitted changes failed to update the database, a failure status page is displayed.

Block 5-8. If the submitted changes were successfully updated in the database, a successful page is displayed.

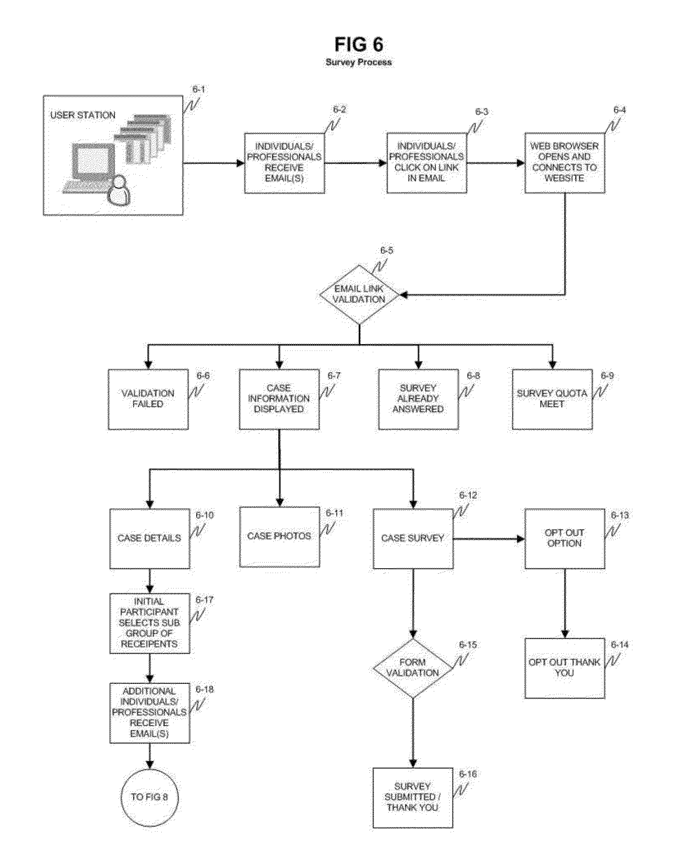

FIG. 6 is a detailed flowchart and shows the process which a doctor/medical professional sees (on any mobile or non-mobile Internet capable communications device) and goes through to submit answers to the surveys emailed to them.

Block 6-1. The selected doctors/medical professionals check and receive the system email(s).

Block 6-2. The doctors/medical professionals review the email received from the system (on any mobile or non-mobile Internet capable communications device)

Block 6-3. They click on the link provided in the email or they may be able to type in the website address if needed in any Internet capable communications device browser.

Block 6-4. The clicked email, Block 6-3, will open up a web capable browser that is loaded on their computer system and connects to the destination website.

Block 6-5. Once the web browser connects, the web site page and programming code does an email link validation to ensure the person connecting to the site is allowed to proceed. If the email link was not properly formatted or if the website address was typed in incorrectly, the doctors/medical professional is redirected to a validation failure on their display, Block 6-6.

If the link or typed in information was properly formatted, the validation process checks the database to see if the doctor/medical professional has already answered and if so they are redirected to a display notifying them that they have already answered this case/survey, Block 6-8, otherwise if they have not answered the case/survey then they are presented with the case details/survey on their display, Block 6-7.

The validation process also checks to see if the maximum number of answers has been met for that particular case/survey. If the survey quota have been meet, the doctors/medical professionals are then redirected to a display notifying them that the case/survey quota have been met, Block 6-9, otherwise if the survey quota for this particular case/survey have not been met, they are presented with the case details/survey on their display, Block 6-7.

Block 6-6. If the link was incorrectly formatted or manually typed incorrectly in the web browser, a validation failed will be displayed along with contact and next step information.

Block 6-7. After all validation, Block 6-5, has been completed and all conditions have passed successfully, the actual case details/survey is presented to their display.

Block 6-8. If the validation, Block 6-5, has determined that the doctor/medical professional has already answered the particular survey, a page will be displayed notifying them that they had already answered this survey and any other information that we may want to present.

Block 6-9. If the validation, Block 6-5, has determined that the case/survey quota have been met and is not accepting any more survey answers, a page will be displayed notifying them that the survey quota have been met and any other information that we may want to present.

Block 6-10. From Block 6-7, the doctors/medical professionals are now presented with the actual case details that have been retrieved from the database.

Block 6-11. This section shows any photos or images associated with the case details and display them on the doctors/medical professional's screen.

Block 6-12. This section shows the survey questions/answers that were generated, FIG. 4 Block 4-6, in the Case Approval process along with other form elements like a comments field.

The doctors/medical professionals are presented with two options. One is to “Opt Out” of the survey, Block 6-13. The other option is to answer the survey and submit their answers for validation, Block 6-15.

Block 6-13. If the doctor/medical profession has chosen to “Opt Out” of the survey, it is recorded into the database and does not count toward the survey quota. This also restricts the doctor/medical professional from coming back and answering, Block 6-8.

Block 6-14. After the doctor/medical professional “Opt Out” status has been recorded into the database, they are redirected and displayed a “Thank You” page.

Block 6-15. If the doctor/medical professional decided to answer the survey, the submitted answers from Block 6-12 are parsed through via software code against defined criteria. The form data must meet minimum defined criteria to be accepted for processing. If a section of the form data is not acceptable, the doctor/medical professional is notified with a screen on their display and allowed to correct the unacceptable data. Once corrected or if all data are considered acceptable, the form data is submitted for data processing.

Block 6-16. Once the submitted survey data has been validated it is then recorded into our database and the doctors/medical professionals are redirected to a display notifying them that their data have been submitted and a “Thank You”.

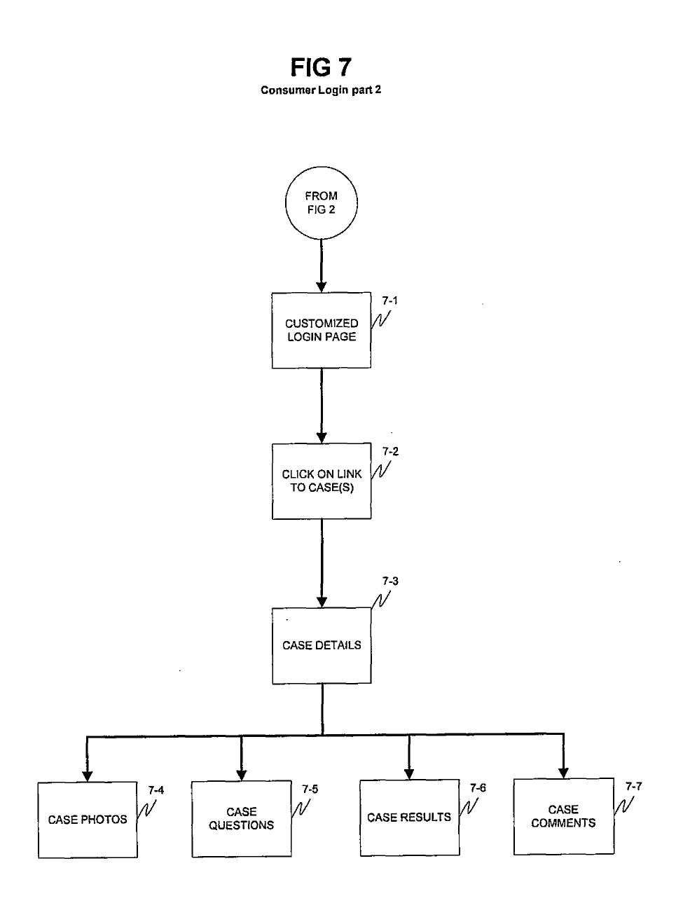

FIG. 7 is a detailed flowchart and is a continuation of the login process from FIG. 2.

Block 7-1. After the customer submits their username and password, FIG. 2 Block 2-2 and the validations are successful, the customer is presented a dynamically generated page that is customized to their type of access.

Block 7-2. If a customer has submitted a case, their cases will be displayed. The customer then clicks on the particular case link they want to view to review case details.

Block 7-3. The case details are displayed with links to other areas of the case, such as but not limited to, case photos, questions, results, etc.

Block 7-4. If a photo was submitted during the sign up process, FIG. 1 Block 1-10, then the clicking on the Images link will display any associated photos.

Block 7-5. The questions that were generated in FIG. 4 Block 4-6 will be displayed when they click on the Questions link.

Block 7-6. The Results page shows the answers in real time as the doctors/medical professionals answer the surveys. The questions and answers are listed along with a graphical representation of the results illustrating the consensus of the opinions recorded on the surveys. The layout or presentation of results is designed to be user friendly such that the user can readily ascertain the individual opinions of the consulting professionals as well as the consensus of the opinions.

Block 7-7. As doctors/medical professionals complete surveys, FIG. 6 Block 5-12, they can submit comments about the case. These comments are displayed in real time when the customer clicks on the Comments link.

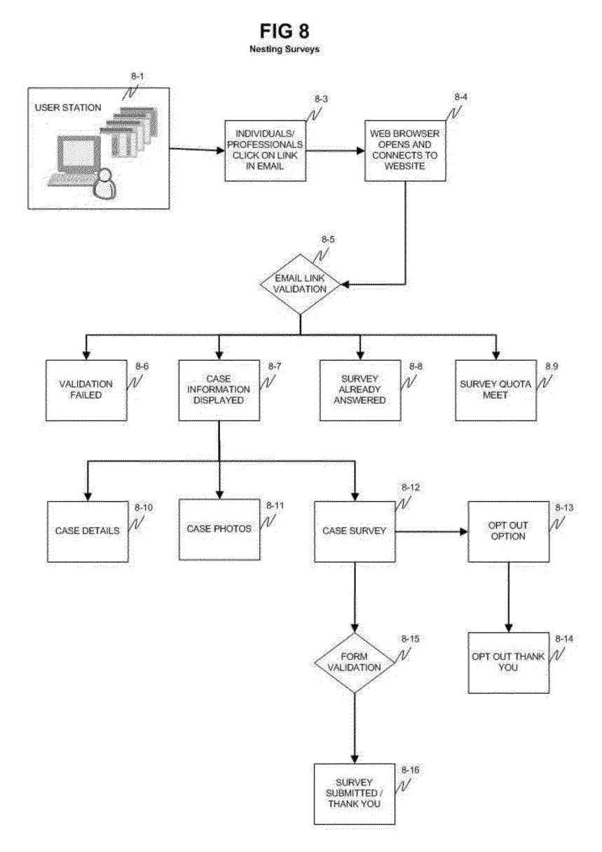

FIG. 8 is a detailed flowchart illustrating the application of the “nested” or “tiered” survey approach which can be used with the basic system illustrated in FIGS. 1-7.

In the simplest scenario, a user of the basic system posts a question using the standard format; professionals affiliated with the system review the submission and create one or more critical questions which are sent in the form of a survey to medical professions chosen by the system from its database who respond to the survey. In the “nested” or “tiered” approach, the scenario is repeated twice, such that the number of responses can be increased dramatically.

Using this approach, a medical professional selected to receive an initial survey will be given the option of defining a group of recipients to respond to a further survey which further survey may be the same as or different the initial survey. The group of recipients defined to receive the further survey can be medical professionals. However, they also could be non-medical professions, such as the patients of the medical professionals selected to receive the initial survey.

With regard to clinical trials specifically, the “nested” or “tiered” approach could be used in many different ways. It could be used for feasibility (enrolling in a theoretical clinical trial) or recruitment (to determine if an individual is interested in an ongoing trial). It could be used in clinical trial design through collective opinions of qualified scientists which could include development of primary, secondary and tertiary endpoints, definition of patient populations and measurement criteria. It could also be employed to determine the feasibility of clinical trial enrollment based on proposed inclusion and exclusion criteria.

This approach is particularly useful for the recruitment of individuals for clinical trials where selected medical professions such as physicians, in turn, contact their patients using the system and prepopulated patient data bases of searchable and appropriate patient emails both for direct email solicitation and patient survey information.

It could be used to analyze results and through collective wisdom surveys. It could also be used to disseminate the results of the clinical trial to physicians and patients.

This approach can also be used for one group of medical professionals to query another group of medical professionals e.g. nationally oriented thought-leading physicians querying local medical professionals in their communities.

In that scenario, the primary user asks physicians a question, choses the physician type and then the system editor enables the physicians to query their own patients using structured emails. The patients would be selected using patient criteria that are preloaded into the system, downloaded from a EHR, or that are added to our database by some other means.

This application provides a means by which doctors can obtain patient level information on their own patients, which they are entitled to do under HIPAA, and then provide de-identified information to the primary user of the system who does not need to go through the many steps to get patient level medical information. In this way, the system can be used twice with different groups to get information that would be difficult to get using other means.

Referring back to Block 6-10 of FIG. 6, that flowchart shows that once the case details have been established, a recipient of the initial survey has the option of defining a second group of recipients to receive a further survey in Block 6-17. Just as the system selected the initial group of survey recipients, in this case the recipients of the initial survey are provided the option of defining their own group of recipients to answer a further survey. Information relating to this group of recipients to receive the further survey will typically be provided by the recipient of the initial survey defining the group for the further survey as a database of patient emails or as a group of colleagues from an address book.

The members of the group defined to receive the further survey receive emails from the system, as indicated in Block 6-18. The emails include a link to access the original survey or to receive a further survey that is tailored to questions that they can best assess. For example, medical professionals selected for the initial survey could be asked about their patient preferences and then the system could ask selected patient questions that would lead the medical professionals to answer the original survey in a specific way.

Now referring to FIG. 8, in Block 8-1 each member of the group defined by the recipient of the initial survey receives an email from the recipient of the initial survey and then clicks on a link in the email in Block 8-3, which brings that individual to the system website in Block 8-4. After validation of the link in Block 8-5, and assuming that the survey has not already been answered by this individual, in Block 8-8, and that the survey quota has not already been met, in Block 8-9, a message is formulated and sent to the individual which may include the appropriate case information, in Block 8-7, such as some or all of the case details, in Block 8-10, and some or all of the case photos in Block 8-11, as well as the further survey in Block 8-12.

The further survey of Block 8-12 may include some or all of the same structured question(s) as the initial survey. Alternatively, that survey may include modification versions of some or all of the structured question(s) of the initial survey or an entirely new set of structured question(s). If modified or new structured question(s) are included, those may be formulated by professionals affiliated with the system, by the recipient of the initial survey that defined the group to receive the further survey, or both.

The process flow for the group defined by the recipient of the initial survey is the same as for recipients of the initial survey. The members of the group defined by the recipient of the initial survey may or may not have access to the details of the case, photos, questions and comments, as appropriate. The same validations apply, such as only allowing an individual to answer once, and cutting off survey responses if and when the maximum number of recipients has been met, etc.

There are three basic ways in which surveys results can be calculated:
Calculation 1—Responses of the recipients of the initial survey and responses from recipients of the further survey selected by the recipients of the initial survey are all tabulated into the overall count, all in real time.
   Example: 100 recipients of the initial survey answer, and each sends out a further survey to 50 individuals members who answer. In this scenario, the total number of responses is 100+100(50)=5100.
Calculation 2—Only the answers of the recipients of the initial survey are tabulated but their answers would be informed based on the answers of the recipients of the further survey.
   Example: 100 recipients of the initial survey answer so the total number of responses is 100. Their responses are based on further surveys answered by their patients
      Example of question from user to system:
   “Of the following over the counter medications, which is mostly likely to be used by your patients who routinely take some sort of treatment before bedtime?
      Aspirin
      Benadryl
      Nyquil
      Tylenol PM”

The recipients of the initial survey who are doctors, in turn, could each then query, say, 100 of their patients. The qualifying question to patients would be whether or not they are in the habit of taking some type of medicine before sleeping on a routine basis. If the question is posed as a single selection response, the accumulation of responses from individuals of the selected group (patients) would either be 100—one response for each doctor showing the most common answer among his or her patients, or (100×100)=10,000 in which every answer of every patient would be tallied.

In the former case, data could help determine if patient use patterns center around characteristics of the individual physician types (for example do male versus female physicians provide different outcomes). In the latter case, most common patient use patterns would be presented across the spectrum. Of course, both “physician—centric” and “patient-centric” responses could be calculated for a “nested” survey and shown in two separate analyses.
Calculation 3—Using a multiple selection response for the above question, patients could indicate ANY of the choices that they take before bedtime. This type of questioning would allow for the system to calculate the most commonly used treatment based not on perception of the recipients of the further survey but based on the percentages of patients who report using any of the products at some time. Again this methodology could be reported as 100 responses (most common by doctor) or 10,000 (actually percentage of patients who at times take the product before bedtime).

In another application, recipients of the further survey defined by recipients of the initial survey could be directed to a website for further information about an issue that they are introduced to by the recipients of the initial survey. An application of this concept would be clinical trial recruiting or feasibility assessments. So, for example, a sponsor of a study asks doctors about whether or not their patients would participate in a clinical trial. If the doctor thinks it is a reasonable trial for patient participation, he or she carries through a “nested” survey to patients with the option to attend an educational session or sign up for screening on a web site linked to the survey.

As a step in the validation process for recipients of the initial survey, in Block 8-5, there would need to be a check for duplicated email addresses to avoid double counting in the case when, for example, the same patient had a relationship with two doctors who both participate in the survey.

It will now be appreciated that the present invention relates to a computer implemented system of providing online medical consultation services by a team of medical professionals. The method begins when a user accesses the system website. The user selects the level of consultation services desired. The user is provided with a payment demand, based upon the level of services selected. The user submits the payment information on a form provided. The submitted payment information is verified. A case submission form is then provided to the user requesting information relating to desired medical consultation. The user provides the requested information on case submission form.

The submitted information on the case submission form is reviewed. A determination is made if additional information is required to process case. If so, the additional information is requested from the suitable source. When the case is ready for submission, members of the medical professional team are selected for consultation on the case. The selected members are forwarded the particulars of the submitted case via the Internet and e-mail. The selected team members review the submitted case particulars and each member provides their medical opinion via Internet.

The submitted opinions to “Critical Questions” for each case are recorded and displayed in real time on the system website to which the user has access. In addition, any submitted comments are compiled. A graphical representation of answers to structured questions and compiled opinions is generated and displayed in real time on the website. Users can quickly view the graphical display and understand whether or not a case has generated a consensus opinion among the responding medical professionals and understand the strength of the consensus, when same exists.

The system of the present invention has a variety of possible applications beyond simply providing the opinions of medical professionals to a patient in order to assist the patient in making a decision as to medical care. For example, the results of the medical opinions, and the strength of the consensus thereof, could be used by potential litigants or their attorneys in deciding whether or not to proceed with a medical malpractice lawsuit based on deviations from a standard of care consensus, to determine what the strength of a lawsuit based on consensus opinions would likely be and whether (or the amount of) a settlement should be considered. It could also be used in arbitration of medical disputes where an award could be based upon the opinions of a number of doctors (an unbiased source) indicating whether a particular course of therapy was within the accepted norm.

The system could be used in public relations or media, for example, where a quick and accurate poll of physicians is needed. This is an area where the number of physicians consulted could be increased to include any number of the database physicians to provide an instant or real time survey or consensus assessment of newsworthy medical items/stories, or an instant or real time assessment of government health policies, for example.

The system also has commercial applications. It could be use to provide an instant or real time consensus relating to a new drug or device, instant or real time health care provider focus groups on medical issues, or instant or real time competitive health assessments, for example, information as to whether the availability of a particular new drug would completely replace need for a pre-existing drug or whether a generic form of a particular drug would make proprietary versions of that drug unnecessary.

The system could be used in formulating health policy. It could be used to measure the acceptance level of a particular policy where the survey questions are designed to elicit physician opinion on upcoming policy, or measure the acceptance level of a certain public health official to determine whether such an individual might be elected to a position, such as the amount of political support for proposed or current FDA Commissioner, for example.

It has applicability in personal physician practices to demonstrate that physicians give advice differently when advising a family member as compared to recommendations for a typical patient. For newer technologies that appear promising but are unproven, the system of the present invention could be used to determine whether a consensus of physicians would use the new technology to treat their own families as a good way for the public to understand when doctors are practicing defensive medicine as opposed to following their true beliefs. Further, the surveys provided by the system could be used to elicit instant/real time physician health behaviors, for example, How much do they exercise? Do they take certain vitamins? etc.

The system of the present invention could be used with health care providers other than doctors. The team of medical professions could consist of or include nurses, chiropractors, pharmacists, etc., as well as or instead of physicians.

The system of the present invention can employ a “nested” or “tiered” approach in which medical professionals selected to receive an initial survey have the option of defining a group of recipients for a further survey, which further survey may be the same or may be different than the initial survey. This approach is particularly well suited for use in clinical trials, where it can assist in the design, the setting of criteria for and the recruit of participants for the clinical trial, as well as in the analysis and disseminating of the results of the clinical trial. Other applications would include extracting information for medical education events or for market research purposes when the initial user needs the assistance of experts to identity and contact further groups who might best address the issue at hand.

The system of the present invention is also well suited for use with various types of mobile Internet capable communications devices, such as smartphones and tablets, through which system users and the system can communicate. Such devices permit communications from any location where mobile communications service is available, at any time.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

We claim:

1. A method of providing medical survey results utilizing a computer-implemented system connected to the Internet, the method comprising the steps of:
(a) creating a database of potential recipients of an initial survey, along with information about each such potential recipient;
(b) user seeking medical survey results accesses system and submits information to system regarding the medical issue for which the user desires survey results;
(c) group of recipients of an initial survey qualified with regard to the medical issue for which the user desires survey results are selected by the system based upon information in the database;
(d) formulating an initial survey including information regarding medical issue for which user desires survey results and one or more structured questions, and forwarding the initial survey to the recipients selected to respond to the initial survey;
(e) selected group of recipients of the initial survey review initial survey and formulate responses which are forwarded to system, at least one such response to the initial survey including a definition of a group of recipients for a further survey;
(f) selecting group of recipients for a further survey in accordance with the definition of a group of recipients for a further survey included in the at least one response of the recipients of the initial survey;
(g) formulating the further survey and forwarding the further survey to recipients selected for the further survey;
(h) recipients of the further survey review further survey and provide responses to system;
(i) system uses responses to formulate medical survey results sought by user, and
(j) system displays results on website accessible to the user.

2. The method of claim 1 wherein the step of selecting a group of recipients for a further survey comprises the steps of: recipient of initial survey supplies system with information relating to the recipients for a further survey defined by such recipient of initial survey and system selects group of recipients for further survey based upon such supplied information.

3. The method of claim 1 further comprising the step of providing access by recipients of the further survey to responses to the initial survey.

4. The method of claim 1 wherein the step of formulating the further survey comprises the step of at least one professional affiliated with the system reviewing responses to the initial survey and preparing the further survey including one or more structured questions, based upon responses to initial survey.

5. The method of claim 1 wherein the step of formulating the further survey comprises the step of recipient of initial survey providing response defining group of recipients for further survey preparing the further survey including one or more structured questions.

6. The method of claim 1 wherein the recipients of said initial survey comprise medical professionals and the recipients of the further survey comprise the patients of said medical professionals.

7. The method of claim 1 wherein the medical survey results provided by the system relate to a clinical trial, the recipients of the initial survey comprise medical professionals and the recipients of the further survey comprise the patients of the medical professionals that are possible participants of such clinical trial.

8. The method of claim 1 wherein the step of system uses responses to formulate medical survey results sought by user comprises system uses response to initial survey to formulate medical survey results sought by user.

9. The method of claim 1 wherein the step of system uses responses to formulate medical survey results sought by user comprises the steps of recipients of the initial survey use responses to the further survey to formulate their responses to initial survey and system uses such responses to initial survey to formulate medical survey results sought by user.

10. The method of claim 1 wherein the step of system uses responses to formulate medical survey results sought by user comprises system uses responses to further survey to formulate medical survey results sought by user.

11. The method of claim 1 further comprising the step of directing the recipients of the further survey to a website to obtain additional information about the medical issue for which user seeks medical survey results.

12. A system for providing medical survey results utilizing a computer-implemented system connected to the Internet, the system comprising: a database of potential recipients of an initial survey, along with information about each such potential recipient; means for user seeking medical survey results to access system and submit information to system regarding the medical issue for which the user desires survey results; means for selecting recipients of an initial survey qualified with regard to the medical issue for which the user desires survey results based upon information in said database; means for formulating an initial survey including information regarding medical issue for which user desires survey results and one or more structured questions, and for forwarding the initial survey to recipients selected to respond to the initial survey; means for selected recipients of the initial survey to review the initial survey and respond to system, at least one such response to the initial survey including a definition of recipients for a further survey; means for selecting recipients for the further survey in accordance with the definition of recipients for a further survey included in said at least one response to the initial survey, means for formulating the further survey and for forwarding same to recipients selected for further survey; means for recipients of the further survey to review the further survey and provide responses to system; means for using the responses to formulate medical survey results sought by user, and means for displaying the results on website accessible to the user.

13. The system of claim 12 wherein said means for selecting recipients for a further survey comprises means for recipient of initial survey to supply system with information relating to the recipients selected for the further survey defined by such recipient of initial survey and means for system to select recipients for the further survey based upon said supplied information.

14. The system of claim 12 further comprising means for providing access by recipients of the further survey to the responses to initial survey.

15. The system of claim 12 wherein said means for formulating the further survey comprises means for at least one professional affiliated with the system to review said responses to initial survey and prepare the further survey including one or more structured questions, based upon said responses to initial survey.

16. The system of claim 12 wherein said means for formulating the further survey comprises means for the recipient of the initial survey providing response defining group of recipients for the further survey to prepare the further survey including one or more structured questions.

17. The system of claim 12 wherein the medical survey results provided by the system relate to clinical trials, wherein said recipients of said initial survey comprise medical professionals and wherein said recipients of the further survey comprise the patients of said medical professionals that are possible participants of such clinical trials.

18. The system of claim 12 wherein said means for using responses to formulate medical survey results sought by user comprises means for using responses to initial survey to formulate the medical survey results sought by user.

19. The system of claim 12 wherein said means for using responses to formulate medical survey results sought by user comprises means for recipients of initial survey to use responses to the further survey to formulate their responses to the initial survey and means for using said responses to the initial survey to formulate the medical survey results sought by user.

20. The system of claim 12 wherein said means for using responses to formulate medical survey results sought by user comprises means for using responses to said further survey to formulate medical survey results sought by user.

21. The system of claim 12 further comprising means for directing recipients of the further survey to a website to obtain additional information about the medical issue for which user seeks medical survey results.

22. A system for providing online medical consultation services including quantitative and qualitative responses to surveys related to medical issues, the system comprising: means for creating a database of potential participating medical professionals, along with information about each the potential participating medical professionals, including the qualifications of the potential participating medical professionals; Internet capable communication means for a user seeking medical consultation services to access the system; Internet capable communication means for user to submit information to the system regarding the desired medical consultation services; means for selecting a panel of medical professionals qualified to provide the desired medical consultation services based upon information in said database; means for electronically providing question(s) based on the user submitted information, and the user submitted information, to the medical professionals in the selected panel such that the medical professionals in the selected panel formulate response(s) to provided question(s) and comments regarding user submitted information; means for electronically forwarding the responses and comments from the medical professionals in the selected panel to the system; means for calculating the degree of consensus of forwarded responses to questions; means for displaying said calculated consensus on a system website accessible to user; and means for displaying said comments forwarded from the medical professionals on a system web site accessible to the user by Internet capable communication means.

23. The system of claim 22 wherein said Internet capable communications means comprises a mobile Internet capable communication means.

24. The system of claim 23 wherein said mobile Internet capable communications means comprises a smartphone.

25. A computer-implemented system for providing medical consultation services connected to the Internet, integrated with human resources provided by professionals affiliated with the system, to form a consensus of opinions by a panel of medical professionals selected by the system but not provided with financial incentives which could bias their decision making, the system comprising: means for creating a database of potential participating medical professionals, along with information about each the potential participating medical professionals, including the qualifications of the potential participating medical professionals; Internet capable communication means for user seeking medical consultation services to accesses the system; Internet capable communications means for user to submit information to the system regarding the desired medical consultation services such that at least one professional affiliated with the system can review the information submitted by the user and structure one or more questions, based upon the user submitted information, for consideration by a panel of selected medical professionals; means for selecting a panel of medical professionals qualified to provide response(s) to the structured question(s) based upon information in said database; means for providing the structured question(s) to the medical professionals in the selected panel such that medical professionals in the selected panel can review the structured question(s) and create responses thereto; means for electronically forwarding the responses from the medical professionals in the selected panel to the system; means for compiling the responses forwarded to the system by the medical professionals in the selected panel; means for calculating the degree of consensus of the responses; and means for displaying the calculated consensus on a system website accessible to the user by Internet capable communication means.

26. The system of claim 25 wherein said Internet capable communications means comprises a mobile Internet capable communication means.

27. The system of claim 26 wherein said mobile Internet capable communications means comprises a smartphone.

28. A computer-implemented system for providing medical consultation services connected to the internet, integrated with human resources provided by professionals affiliated with the system, to form a consensus of opinions by a panel of medical professionals selected by the system, the system comprising: means for creating a database of potential participating medical professionals, along with information about each the potential participating medical professionals, including the qualifications of the potential participating medical professionals; Internet capable communications means for user seeking medical consultation services to accesses the system; Internet capable communications means for user to submit information to the system regarding the desired medical consultation services such that at least one professional affiliated with the system can review the information submitted by the user and structure one or more questions, based upon the user submitted information, for consideration by a panel of selected medical professionals; means for selecting a panel of medical professionals qualified to provide response(s) to the structured question(s) based upon information in said database; means for providing the structured question(s) to the medical professionals in the selected panel such that medical professionals in the selected panel can review the structured question(s) and create responses thereto; means for electronically forwarding the responses from the medical professionals in the selected panel to the system; means for compiling the responses forwarded to the system by the medical professionals in the selected panel; means for calculating the degree of consensus of the responses; and means for displaying the calculated consensus on a system web site accessible to the user through Internet capable communications means.

29. The system of claim 28 wherein said Internet capable communications means comprises a mobile Internet capable communication means.

30. The system of claim 29 wherein said mobile Internet capable communications means comprises a smartphone.

31. A method of providing online medical consultation services utilizing a computer-implemented system connected to the Internet to obtain quantitative and qualitative medical opinions from a panel of selected medical professionals, the method comprising the steps of:
(a) creating a database of potential participating medical professionals, along with information about each potential participating medical professional, including the qualifications of the potential participating medical professional;
(b) user seeking a medical consultation accesses the system through Internet capable communications device;
(c) user submits information regarding the desired medical consultation through Internet capable communications device;
(d) system selects a panel of medical professionals qualified to provide desired medical consultation based upon information in the database;
(e) question(s) based on user submitted information and user submitted information are provided to the medical professionals in the selected panel;
(f) medical professionals in the selected panel formulate response(s) to provided question(s) and comments regarding user submitted information;
(g) responses and comments from the medical professionals in the selected panel are forwarded to the system; and
(h) system calculates the degree of consensus of responses to questions, and displays same, along comments from the medical professionals, on a system website accessible to the user through Internet capable communications device.

32. The system of claim 31 wherein said Internet capable communications means comprises a mobile Internet capable communication means.

33. The system of claim 32 wherein said mobile Internet capable communications means comprises a smartphone.

34. A system for providing online medical consultation services including quantitative and qualitative medical opinions from a panel of selected medical professionals, the system comprising: means for creating a database of potential participating medical professionals, along with information about each the potential participating medical professionals, including the qualifications of the potential participating medical professionals; Internet capable communications means for a user seeking medical consultation services to access the system; Internet capable communications means for user to submit information to the system regarding the desired medical consultation services; means for selecting a panel of medical professionals qualified to provide the desired medical consultation services based upon information in said database; means for electronically providing question(s) based on the user submitted information, and the user submitted information, to the medical professionals in the selected panel such that the medical professionals in the selected panel formulate response(s) to provided question(s) and comments regarding user submitted information; means for electronically forwarding the responses and comments from the medical professionals in the selected panel to the system; means for calculating the degree of consensus of forwarded responses to questions; means for displaying said calculated consensus on a system website accessible to user; and means for displaying said comments forwarded from the medical professionals on a system website accessible to the user through Internet capable communications means.

35. The system of claim 34 wherein said Internet capable communications means comprises a mobile Internet capable communication means.

36. The system of claim 35 wherein said mobile Internet capable communications means comprises a smart phone.

37. The method of claim 1 wherein the medical survey results provided by the system relate to medical education.

38. The system of claim 12 wherein the medical survey results provided by the system relate to medical education.

39. The method of claim 1 wherein the medical survey results provided by the system relate to market research.

40. The system of claim 12 wherein the medical survey results provided by the system relate to market research.

41. The method of claim 1 wherein users communicate with the system through Internet accessible communications devices.

42. The system of claim 12 wherein users communicate with the system through Internet accessible communications devices.
